(19) United States
(12) Patent Application Publication
(10) Pub. No.: US 2011/0206532 A1
(43) Pub. Date: Aug. 25, 2011

(54) ELECTROLESS METAL COATINGS

(75) Inventors: Francesco Sorbo, Firenze (IT); Lawrence Bernard Kool, Clifton Park, NY (US); William Clarke Brooks, Lebanon, OH (US); Massimo Giannozzi, Firenze (IT); Eugenio Giorni, Firenze (IT); Thomas Lancsek, Trenton, NJ (US); Steven Alfred Tysoe, Ballston Spa, NY (US); Dennis Michael Gray, Delanson, NY (US); Todd Charles Curtis, Schenectady, NY (US)

(73) Assignee: GENERAL ELECTRIC COMPANY, SCHENECTADY, NY (US)

(21) Appl. No.: 12/710,691

(22) Filed: Feb. 23, 2010

(51) Int. Cl. F04D 29/24; B05D 3/02; B32B 15/04; B32B 15/01

(52) U.S. Cl. 416/241 R; 427/383.1; 427/383.7; 428/457; 428/680

(57) ABSTRACT

The present invention provides a method for preparing an electroless nickel coating composition that includes (a) coating a substrate with an electroless nickel coating to provide a coated substrate; and (b) subjecting the coated substrate to a heating protocol comprising heating to a temperature in a range from about 550° C. to about 700° C. for a period of from about 7 to about 30 hours. An article made from the method is also provided.

### BACKGROUND

The invention relates generally to an electroless metal coating composition and more particularly to a method for electroless nickel coating and articles made therefrom.

Electroless metal coatings are used in a wide variety of applications in which a protective coating is needed to improve the performance characteristics of the substrate underlying the electroless metal coating. The utility of such coatings lies chiefly in the enhanced physical properties (for example hardness) of the electroless metal coating relative to the substrate on which it is disposed. In addition, electroless metal coatings may be used to protect an article which is otherwise susceptible to corrosion from chemicals present in environments in which the article is employed. In addition, because electroless metal coatings are applied to the substrate from solution, the substrate may have a variety of shapes, sizes and perforations and still achieve a coating of uniform composition and thickness. A substantial body of information regarding the preparation and properties of electroless metal coatings is currently available, particularly in the area of coatings comprising nickel-phosphorous or nickel-boron alloys.

Notwithstanding the technical achievements made to date in the area of electroless metal coatings, further improvements are needed in order to maximize the utility of these coatings. Generally, electroless nickel coatings do not have the strain tolerance necessary to withstand the strains experienced during operation of rotating machinery. Standard electroless nickel coatings show spallation due to poor adhesion to the substrate when the coating is exposed to conditions such as high temperature and rotational movement. In addition, another limitation seen in standard coatings is cracking of the coating when placed in a high strain environment. It is important that the coatings resist cracking since cracks in an electroless nickel coating disposed upon a corrosion sensitive substrate may allow fluid communication between a corrosive environment and the corrosion sensitive substrate. Typically, high temperature heat treatment of electroless nickel coated articles results in a change in coating microstructure leading to poor strain tolerance or corrosion resistance of the heat treated electroless nickel coating. Poor adhesion and/or coating cracking of the electroless metal coating can lead to a shortened useful lifespan of the article comprising the electroless metal coating. In addition, the article may be corroded due to lack of protection by the coating layer in harsh chemical environment such as a sour gas environment.

There is therefore a need for electroless nickel coatings displaying both enhanced adhesion and strain tolerance to enable coatings to provide protection from chemicals especially during high speed operation by means other than resubjecting the substrate to electroless metal coating conditions. Therefore, it would be advantageous to provide articles comprising robust electroless metal coatings which are ductile, largely free of imperfections such as cracks and pinholes, and which resist separation of the coating from the underlying substrate, and to provide methods for the preparation of such articles.

### BRIEF DESCRIPTION

In accordance with one aspect of the present invention, a method for preparing an electroless nickel coating composition is provided that includes (a) coating a substrate with an electroless nickel coating to provide a coated substrate; and (b) subjecting the coated substrate to a heating protocol comprising heating to a temperature in a range from about 550° C. to about 700° C. for a period of from about 7 to about 30 hours.

In accordance with another aspect of the present invention, a method for preparing an electroless nickel coating composition is provided that includes (a) coating a low alloy steel substrate with an electroless nickel coating to provide a coated substrate; and (b) subjecting the coated substrate to a heating protocol comprising heating to a temperature in a range from about 550° C. to about 700° C. for a period of from about 7 to about 20 hours.

In accordance with another aspect of the present invention, a composition comprising an electroless nickel coating in contact with a low alloy steel substrate is provided, wherein the composition is prepared by a method comprising the steps (a) coating a low alloy steel substrate with an electroless nickel coating to provide a coated substrate; and (b) subjecting the coated substrate to a heating protocol comprising heating to a temperature in a range from about 550° C. to about 700° C. for a period of from about 7 to about 30 hours.

In accordance with yet another aspect of the present invention, a method is provided for preparing an electroless nickel coating composition, the method comprising (a) coating a substrate with a first electroless nickel coating to provide a first coated substrate; (b) coating the first coated substrate with a second electroless nickel coating to provide a second coated substrate; and (c) subjecting the second coated substrate to a heating protocol comprising heating to a temperature in a range from about 550° C. to about 700° C. for a period of from about 7 to about 30 hours.

### DETAILED DESCRIPTION

In the following specification and the claims, which follow, reference will be made to a number of terms, which shall be defined to have the following meanings.

The singular forms “a”, “an” and “the” include plural referents unless the context clearly dictates otherwise.

“Optional” or “optionally” means that the subsequently described event or circumstance may or may not occur, and that the description includes instances where the event occurs and instances where it does not.

As used herein, the term “solvent” can refer to a single solvent or a mixture of solvents.

It is also understood that terms such as “top,” “bottom,” “outward,” “inward,” and the like are words of convenience and are not to be construed as limiting terms. Furthermore, whenever a particular feature of the invention is said to comprise or consist of at least one of a number of elements of a group and combinations thereof, it is understood that the feature may comprise or consist of any of the elements of the group, either individually or in combination with any of the other elements of that group.

Approximating language, as used herein throughout the specification and claims, may be applied to modify any quantitative representation that could permissibly vary without resulting in a change in the basic function to which it is related. Accordingly, a value modified by a term or terms, such as “about”, is not to be limited to the precise value specified. In some instances, the approximating language may correspond to the precision of an instrument for measuring the value.

As noted, in one embodiment, the present invention provides a method for preparing a electroless nickel coating composition. The method includes (a) coating a substrate with an electroless nickel coating to provide a coated substrate; and (b) subjecting the coated substrate to a heating protocol. The heating protocol includes heating to a temperature in a range from about 550° C. to about 700° C. for a period of from about 10 to about 30 hours.

As used herein, the term electroless nickel coating refers to a nickel coating on a substrate formed by chemical reduction of nickel ions in solution in the presence of the substrate. A variety of such electroless metal coatings is known in the art and includes electroless copper coatings, electroless gold coatings, electroless silver coatings, and electroless nickel coatings. In one embodiment, the electroless nickel coating provided by the present invention is a nickel-phosphorous alloy coating. In an alternate embodiment, the electroless nickel coating provided by the present invention is a nickel-boron alloy coating. In yet another embodiment, the electroless nickel coating provided by the present invention is an electroless nickel coating comprising poly(tetrafluoroethylene).

The substrate can be any substrate capable of supporting the electroless nickel coating but is typically a material for which the electroless nickel coating displays suffficient affinity to form a stable coating thereupon. Substrates may be inorganic materials such as metals, or organic materials such as plastics, or composite materials, for example an organic polymer comprising an inorganic filler. In one embodiment, the substrate is a metal substrate. In one embodiment, the coating may form diffusion bond layer between the electroless nickel coating composition and the metal substrate. The formation of such a diffusion bond layer results in electroless nickel coatings possessing exceptional performance characteristics resulting from an intermingling of the substrate and the coating within the diffusion bond layer. Non-limiting examples of suitable metal substrates include iron, chromium, nickel, cobalt, copper, aluminum, titanium, and the like. In another embodiment, the substrate comprises steel. In one embodiment, the substrate comprises low alloy steel, for example low alloy carbon steel.

In one embodiment, the electroless nickel coating composition comprises phosphorous. Such coating compositions may at times herein be referred to as electroless nickel phosphorous coating compositions. In one embodiment, the electroless nickel phosphorous coating composition comprises sufficient phosphorous to be recognized as a “high phosphorous” electroless nickel coating composition. Those of ordinary skill in the art will understand that such high phosphorous coatings offer outstanding resistance to corrosive environments. In another embodiment, the electroless nickel coating composition is characterized as “low phosphorous” Again, those of ordinary skill in the art will appreciate the advantages of such low phosphorous electroless nickel coating compositions. In one embodiment, the electroless nickel coating composition comprises phosphorus in a range from about 1 percent to about 8 percent. In another embodiment, the electroless nickel coating composition comprises phosphorus in a range from about 2 percent to about 5 percent.

In yet another embodiment, the electroless nickel coating composition comprises poly(tetrafluoroethylene) particles. Such electroless nickel composite coating compositions are prized for reduced surface friction at contact points with other surfaces, for example where the electroless nickel composite coating composition is in contact with another moving part in a device or machine.

As noted, the electroless nickel coating is typically of relatively uniform thickness. In one embodiment, the electroless nickel coating has an average thickness in a range from about 1 micron to about 250 microns. In another embodiment, the electroless nickel coating has an average thickness in a range from about 25 microns to about 100 microns. In yet another embodiment, the electroless nickel coating has an average thickness in a range from about 50 micron to about 100 microns.

In one embodiment, the coated substrate may include a multilayer electroless nickel coating. In one embodiment, the coated substrate may include at least two layers of an electroless nickel coating. In another embodiment, the method includes coating the substrate with a first layer of electroless nickel coating, followed by cleaning the substrate coated with the first layer of the electroless nickel coating and then laying down at least one more additional layer of the electroless nickel coating composition.

As noted, in one embodiment, the present invention provides a method for preparing an electroless nickel coating composition, the method includes (a) coating a substrate with a first electroless nickel coating to provide a first coated substrate; (b) coating the first coated substrate with a second electroless nickel coating to provide a second coated substrate; and (c) subjecting the second coated substrate to a heating protocol comprising heating to a temperature in a range from about 550° C. to about 700° C. for a period of from about 7 to about 30 hours. In one embodiment, subjecting the second coated substrate to said heating protocol creates a diffusion bond layer between the substrate and one or more electroless nickel coating layers. In one embodiment, the heating protocol merges the first electroless nickel coating layer with the second electroless nickel coating layer such there is no detectable boundary region between the first electroless nickel coating layer with the second electroless nickel coating layer. In one embodiment, the diffusion bond layer has a thickness in a range from about 1-20% of the thickness of the one or more electroless nickel coating layers.

As noted, the present invention provides a method for preparing electroless nickel composition comprising subjecting the coated substrate to a specific heating protocol identified herein and forming part of the claimed invention. The heating protocol comprises heating the coated substrate to a temperature in a range from about 550° C. to about 700° C. In one embodiment, the heating protocol comprises heating the substrate to a temperature in a range from about 600° C. to about 650° C. As noted the heating protocol comprises heating for a period in a range from about 7 hours to about 30 hours. In one embodiment, the heating is carried out for a period in a range from about 10 hours to about 25 hours. In another embodiment, the heating is carried out for a period in a range from about 15 hours to about 25 hours.

As noted, the heating protocol used according to the present invention comprises heating the coated substrate to a high temperature from an initial temperature. In one embodiment, the heating is carried out at a heating rate in a range from about 5° C. per minute to about 20° C. per minute. In another embodiment, the heating is carried out in a range from about 8° C. per minute to about 12° C. per minute. In another embodiment, the heating protocol comprises heating the coated substrate to a temperature of about 600° C. for a period of 20 hours at a heating rate of about 10° C. per minute.

In one embodiment, the present invention provides an article comprising at least one surface that is coated with an electroless nickel coating composition prepared using the method described herein. Suitable articles are exemplified by but are not limited to turbo pumps, turbines which may include gas turbines, steam turbines, water turbines, centrifugal pumps, impeller for high pressure pump, turbo fans, dydrodynamic gear box, compressors, oil field valves, rotors, rotor blades, rotor shafts, drive shafts, paper handling equipment, fuel rails, optical surfaces for diamond turning, door knobs, kitchen utensils, bathroom fixtures, electrical tools, mechanical tools, and coatings used in electronic printed circuit board manufacture. As noted, the electroless nickel coatings provided by the present invention serve to protect the underlying substrate comprised within the article from, for example, wear and tear and corrosion. In one embodiment, the article is an impeller for a high pressure pump. In one embodiment, the article may be a centrifugal compressor impeller. In another embodiment, the article may be a pipe the inside of surfaces of which are coated with an electroless nickel coating provided by the present invention. Other articles advantageously comprising the electroless nickel coatings provided by the present invention include housings such as valve housing cavities where corrosion protection is required.

In one embodiment, the electroless nickel coating composition is diffusion bonded to the substrate via the formation of a diffusion layer on heat treatment.

Those of ordinary skill in the art will appreciate that one of the advantages provided by the present invention is that the electroless nickel coating displays beneficial properties for example good corrosion resistance, good adhesion to the substrate, and high ductility. In one embodiment, the electroless nickel coatings provided by the present invention exhibit good corrosion resistance and a high degree of strain tolerance with adequate adhesion to the substrate, where the properties of the standard coatings are not adequate for the stresses and strains seen on rotating equipment such as compressor impellers.

### Example

Electroless Nickel Plating General: Test samples were subjected to electroless nickel plating (EPN) on a low alloy steel (A182F22) substrate and an electroless nickel metal coating in contact with the surface of the substrate. The electroless nickel coatings provided by the present invention may be characterized by a variety of techniques known to those of ordinary skill in the art, for example by SEM and optical microscopy.

### Pre-Cleaning of the Sample

The sample to be coated is inspected for any damage, scratches, scrapes, scuffs, rust spots, or other flaws. The sample is then precleaned by immersing the sample in organic solvent such as acetone or isopropyl alcohol to remove any oil that may be present on the sample. The precleaning step involves an acetone soak, a grit blast, a caustic wash with brushing, followed by a careful visual inspection after cleaning to ensure complete removal of all chemicals. The sample is rinsed with deionized water (1-20 microSiemens) for about 1 minute. Following the rinsing with deionized water the sample is immersed in commercially available caustic soap cleaning solution (120 g/L) for about 10 minutes with rotation at 4 rpm at 85° F. This is followed by rinsing the sample with deionized water (1-20 microSiemens) for about 1 minute. The sample is then immersed in hydrochloric acid solution (30% by volume of 37% w/w HCl stock) for about 1-5 minutes with rotation at room temperature to clean the surface. The sample is once again rinsed with deionized water to provide a clean sample.

### Sample Surface Preparation

Chemical etching of the clean sample is carried out under optimized conditions to promote good physical adhesion of the coating to the substrate prior to heat treatment. Chemical etching is carried out using a solution of oxalic acid (31.25 g/L), sulfuric acid (conc., 1.25 mL/L) and hydrogen peroxide (35%, 16.0 mL/L) at a temperature of about 25° C. for a period of about 10 minutes. Following the chemical etching the etched sample is rinsed with deionized water (1-20 microSiemens) for about 1 minute. The etched sample after being rinsed with deionized water is subjected to ultrasonic cleaning to remove smut that may be present in the sample. The sonification was carried out in tap water for about 5 minutes at room temperature followed by rinsing with deionized water. The sample was then treated with a NaOH wash and a HCl wash as described above in the pre-cleaning step to provide a surface prepared sample.

### Electroless Nickel Plating:

Glassware used in electroless plating procedures is either newly purchased or first treated with 10% nitric acid for 2 hours at 60° C. The glassware is then thoroughly rinsed with filtered high purity water and sealed with PARAFILM.

Electroless Plating Solution: A clean Erlenmeyer flask is charged in order with the following: filtered high purity water (1000 mL), sodium hypophosphite (27 grams), nickel sulfate (20 grams) and sodium succinate (16 grams). Care is taken that no magnetic stir bars are used. The resultant solution is vacuum filtered through a 0.6 micron or finer Millipore filter (45 mm diameter filter) into a clean vacuum flask and the filtered solution is transferred to a clean Erlenmeyer flask and sealed with PARAFILM.

### Example 1

The surface prepared sample is pre-heated and fixed on a fixture prior to it being immersed in the electroless plating solution. The pH of the electroless plating solution is monitored using a pH strip sensitive in the range pH 5 to pH 8 and is maintained at about pH 7 through the dropwise addition of lactic acid solution. Care is taken to avoid the presence of any sodium hydroxide to prevent the formation of nickel hydroxide as a precipitate. The sample is rotated at a speed of about 4 rotations per minute and is submerged simultaneously at the beginning of the plating step. At the end of 30 seconds, bubbling occurs indicating the beginning of the plating. The sample is rotated at constant speed in the electroless plating solution. The plating rate is maintained at about 0.75 mil/hr for a period of about 2.5 hrs at a temperature of about 85° C., at a pH of about 5.9. The thickness of the applied coating is monitored with witness coupons (typically Razor blades or immersion disks) and measured using a micrometer. Once the required thickness of the coating is achieved the sample is removed and placed in a rinse tank (with rotation) to wash off any electroless plating solution and provide a coated sample.

### Post Plating Treatment

The coated sample is then dipped in a solution of hydrogen peroxide (5% v/v of 37%) stock, at a temperature of about 72° C., for a period of 8-10 minutes to form very thin oxide layer on coated sample. The coated sample is packed in bag under hot air to insure moisture does not come in contact with part. The coated sample is then tested for the presence of any imperfections in the electroless nickel plating using the ferroxyl test, ASTM B733. The presence of a deep blue color during the ferroxyl test indicates the presence of pinhole imperfections in the electroless nickel plating coating allowing fluid communication between the steel substrate and the ferric chloride test solution.

The coated sample is then baked at a temperature of 180° C. in air for a period of about 2 h to remove hydrogen from the sample. The sample is then subjected to a heating protocol identified as part of the present invention which both alters the microstructure of the electroless nickel coating and creates a diffusion bond layer between the substrate and the electroless nickel coating. Thus, the sample is heated under vacuum at a temperature of about 600° C. for a period of 20 hours. The heating carried out such that the coated article is heated from an initial temperature to about 600° C. at a rate of about 10° C. per minute ramp until the conditioning temperature (600° C.) is attained.

Strain tolerance measurements were carried out for the coated samples using both a four point bend test and using standard round tensile bars for verification. Prior to strain measurements the coated sample was subjected to Ferroxyl and dye penetrant test to make sure there were no cracks or through thickness defects. The coated samples were strained in 0.1% increments. After each 0.1% increment the coated samples were inspected for cracks using the florescent dye penetrant. This procedure was continued until cracks were noticed. The strain tolerance numbers reported in Table 1 from the four point bend measurements and are the maximum strain measured before cracking is observed except for the case where the sample was heat treated at about 600° C. for a period of about 20 hrs where no cracks were seen even at 2% strain.

TABLE 1
Strain tolerance measurement values at various stages of
heating profile.

| Heating | | |
|---|---|---|
| Temperature | | |
| (° C.) | Duration (hrs) | Strain Tolerance |
| 550 | 1 | 0.2 |
| | 1 | 0.2 |
| | 1 | 0.2 |
| | 6 | 0.2 |
| | 6 | 0.2 |
| | 6 | |
| | 12 | 0.3 |
| | 12 | 0.3 |
| | 12 | 0.4 |
| | 20 | 0.7 |
| | 20 | 0.7 |
| | 20 | 0.9 |
| 600 | 1 | 0.3 |
| | 1 | 0.3 |
| | 1 | 0.3 |
| | 6 | 0.5 |
| | 6 | 0.5 |
| | 6 | 0.5 |
| | 12 | 0.5 |
| | 12 | 0.5 |
| | 12 | 0.6 |
| | 20 | 2 |
| | 20 | 2 |
| | 20 | 2 |
| 650 | 1 | .2 |
| | | .3 |
| | | .3 |
| 450-500-550 | 1 hr each | .2 |
| | | .2 |
| | | .2 |
| 550-600-650 | 1 hr each | .6 |
| | | .6 |
| | | .7 |

Data given in Table 1 demonstrate that electroless nickel coatings prepared according to the method of present invention display exceptional strain tolerance relative to electroless nickel coatings prepared using other protocols.

The Vicker's microindentation hardness was measured for the coated samples according to the ASTM Method E-384. The results are shown in Table 2.

TABLE 2
Vicker's Microindentation Hardness Data

| | | |
|---|---|---|
| | | Vicker's Hardness |
| Temperature | Duration | (Kg/mm²) |

| (° C.) | (hrs) | Mean | Std. Dev. |
|---|---|---|---|
| 550 | 1 hr | 494 | 13 |
| | 6 hr | 441 | 8 |
| | 12 hr | 423 | 6 |
| | 20 hr | 341 | 2 |
| 600 | 1 hr | 431 | 10 |
| | | 416 | 12 |
| | 6 hr | 358 | 17 |
| | | 329 | 25 |
| | 12 hr | 348 | 12 |
| | | 336 | 13 |
| | 20 hr | 291 | 11 |
| | | 290 | 9 |
| 650 | 1 hr | 436 | 5 |
| 450-500-550 | 1 hr each | 497 | 10 |

As can be observed from Tables 1 and 2 higher temperatures and longer heat-treat times resulted in lower hardness and better strain tolerance. As can be seen a heating profile of 600° C. for a duration of 20 hrs resulted in a strain tolerance of greater then 2%, much higher than the comparative sample which has a strain tolerance of less than 1%.

### Example 2

The surface prepared sample (an impeller component made from A182F22 low alloy steel) was coated with the electroless nickel coating composition as described in Example 1 as described above. The surface prepared sample is pre-heated and fixed on a fixture prior to it being immersed in the electroless plating solution. The pH of the electroless plating solution is monitored using a pH strip and sensitive in the range pH 5 to pH 8 and is maintained at about pH 7 through the dropwise addition of lactic acid solution. Care is taken to avoid the presence of any sodium hydroxide to prevent the formation of nickel hydroxide as a precipitate. The sample is rotated at a speed of about 4 rotations per minute and is submerged simultaneously at the beginning of the plating step. At the end of 30 seconds, bubbling occurs to indicate the beginning of the plating. The sample is rotated at a continuous speed in the electroless plating solution. The plating rate is maintained at about 0.325 mil/hr for a period of about 1.25 hrs at a temperature of about 85° C., at a pH of about 5.9. At the end of the stipulated time, the sample was removed from the plating bath to provide a first coated substrate. The surface of the first coated substrate was treated with hydrochloric acid (30% by volume of 37% w/w HCl stock) for about 1-5 minutes with rotation at room temperature to clean the surface. The clean first coated substrate was once again rinsed with deionized water and fixed on a fixture then immersed in the electroless plating solution for about 1.25 hrs to provide a second coated substrate comprising two electroless nickel coating layers. The second coated substrate was then subjected to a heating protocol comprising heating to a temperature of about 600° C. for a period of about 20 hrs under vacuum.

Coatings were characterized of the coating is by metallography (SCM and EDS). In one test procedure the coated substrate was cut to provide a cross section of the substrate coating interface which was examined with an optical microscope. Test samples provided by the present invention exhibited a 2-3 micrometer thick diffusion bond layer between the sample and the electroless nickel coating. The diffusion bond layer was shown by EDS to contain both iron from the substrate and nickel from the electroless nickel coating.

The heating protocol provided by the present invention results in the creation of a diffusion bond between the substrate and the electroless nickel coating which in addition to improving the adhesion properties of the coating improves the strain tolerance of the electroless nickel coating. Thus in one embodiment, the present invention provides a coated impeller comprising an electroless nickel coating. It is believed that coated articles prepared using the method of the present invention exhibit coating ductility sufficient to withstand the stresses produced at very high (20000 RPM) rotational speeds. As part of the research effort described herein, it was observed that the substrate coated with multiple layers of an electroless nickel coating prior to being subjected to the heating protocol provided by the present invention provided even better control of through-coating defects such as pinholes and through-coating cracks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method for preparing an electroless nickel coating composition, the method comprising:
(a) coating a substrate with an electroless nickel coating to provide a coated substrate;
(b) subjecting the coated substrate to a heating protocol comprising heating to a temperature in a range from about 550° C. to about 700° C. for a period of from about 7 to about 30 hours.

2. The method according to claim 1, wherein the coated substrate comprises a multilayer electroless nickel coating.

3. The method according to claim 1, wherein the substrate is a metal substrate.

4. The method according to claim 1, wherein the substrate comprises a low alloy steel.

5. The method according to claim 1, wherein the electroless nickel coating composition further comprises phosphorous a range from about 1% to about 8%.

6. The method according to claim 1, wherein the electroless nickel coating composition further comprises phosphorous in a range from about 2% to about 5%.

7. The method according to claim 1, wherein the coating has a thickness in a range from about 1 micron to about 250 microns prior to being subjected to the heating protocol.

8. The method according to claim 1, wherein the coating has a thickness in a range from about 25 micron to about 100 microns prior to being subjected to the heating protocol.

9. The method according to claim 1, wherein the heating protocol comprises heating to a temperature in a range from about 625° C. to about 675° C.

10. The method according to claim 1, wherein the heating is carried out for a period in a range from about 15 hours to about 25 hours.

11. The method according to claim 1, wherein the heating is carried out at a heating rate period in a range from about 5° C. per minute to about 20° C. per minute.

12. The method according to claim 1, wherein the heating is carried out at a heating rate period in a range from about 8° C. per minute to about 12° C. per minute.

13. An electroless nickel coating composition prepared by the method of claim 1.

14. An article prepared by the method of claim 1.

15. The article according to claim 4, which is an impeller for a high pressure pump.

16. A method for preparing an electroless nickel coating composition, the method comprising:
(a) coating a low alloy steel substrate with an electroless nickel coating to provide a coated substrate;
(b) subjecting the coated substrate to a heating protocol comprising heating to a temperature in a range from about 550° C. to about 700° C. for a period of from about 7 to about 30 hours.

17. The method according to claim 16, wherein further the electroless nickel coating composition further comprises phosphorous a range from about 1% to about 8%.

18. The method according to claim 16, wherein the coating has a thickness in a range from about 1 micron to about 250 microns prior to being subjected to the heating protocol.

19. The method according to claim 16, wherein the heating protocol comprises heating to a temperature in a range from about 625° C. to about 675° C.

20. The method according to claim 16, wherein the heating is carried out at a heating rate period in a range from about 5° C. per minute to about 20° C. per minute.

21. A composition comprising an electroless nickel coating in contact with a low alloy steel substrate, the composition being prepared by a method comprising the steps:
(a) coating a low alloy steel substrate with an electroless nickel coating to provide a coated substrate; and
(b) subjecting the coated substrate to a heating protocol comprising heating to a temperature in a range from about 550° C. to about 700° C. for a period of from about 7 to about 30 hours.

22. A method for preparing an electroless nickel coating composition, the method comprising:
(a) coating a substrate with a first electroless nickel coating to provide a first coated substrate;
(b) coating the first coated substrate with a second electroless nickel coating to provide a second coated substrate; and
(c) subjecting the second coated substrate to a heating protocol comprising heating to a temperature in a range from about 550° C. to about 700° C. for a period of from about 7 to about 30 hours.

23. The method according to claim 22, wherein the substrate is a metal substrate.

24. The method according to claim 22, wherein subjecting the second coated substrate to said heating protocol creates a diffusion bond layer between the substrate and the one or more electroless nickel coatings.

25. The method according to claim 24, wherein the diffusion bond layer has a thickness in a range from about 1-20% of the thickness of the one or more electroless nickel coatings.
